(19) United States
(12) Patent Application Publication
(10) Pub. No.: US 2014/0032642 A1
(43) Pub. Date: Jan. 30, 2014

(54) CONTROLLING SERVER RESPONSE BASED ON CLIENT PERFORMANCE

(71) Applicants: Sailatha Karthikeyan, Bangalore (IN); Sachin Prasad, Bangalore (IN)

(72) Inventors: Sailatha Karthikeyan, Bangalore (IN); Sachin Prasad, Bangalore (IN)

(73) Assignee: INTERNATIONAL BUSINESS MACHINES CORPORATION, Armonk, NY (US)

(21) Appl. No.: 13/561,124

(22) Filed: Jul. 30, 2012

(51) Int. Cl. G06F 15/16

(52) U.S. Cl. 709/203

(57) ABSTRACT

Embodiments of the present invention provide a system, method, and program product for optimizing content sent from a web server to a client device based on client device performance. A client device requests to access web content on a web server, and included in the request are performance competence details corresponding to at least in part hardware capabilities, software capabilities, connectivity quality, and system health of the client device. The performance competence details from the client device and known performance capabilities of the hardware, software, connectivity, and system health of the client device are input into an algorithm to calculate a performance competence index value. The performance competence index value is used to determine an optimal response corresponding to the performance capabilities of the client device. The optimal response is then sent to the client device by the web server.

### FIELD OF THE INVENTION

The present invention relates generally to Web content browsing, and more particularly to customized Web content retrieval on client devices.

### BACKGROUND

There is a wide array of client devices (laptops, mobile devices, etc.) with varying processing power that are constantly accessing content through the internet. Even though client devices exist that have very fast CPUs (Central Processing Units) and high processing power, there exist client devices that have a difficult time loading a simple picture. There also are client devices that are equipped with configurable computing power and processing ability. Given that client devices exist with varying processing abilities, many still share the same operating software. An example of this is the Android operating system for mobile devices, which may be used on state of the art devices, as well as devices that are multiple years old.

Currently, the complexity of the web content that is sent to the client device is based on only a few parameters that primarily send a simplified version of the content to a mobile device compared to a workstation device. However, since such a wide array of client devices exist, some client devices receive content that is difficult for their CPUs to process. Also, the amount of different users of the internet is increasing, and so is the richness of the web content available. Since mobile devices with internet access have become more readily available, more users are able to explore web content than ever before. Web content consists of a wide array of content that ranges from a text web page to streaming HD (High Definition) video. This means that many client devices with limited processing power have access to content that is very difficult for the CPUs of the client devices to process.

### SUMMARY

Embodiments of the present invention provide a system, method, and program product for optimizing content sent from a web server to a client device based on client device performance. A client device requests to access web content on a web server, and included in the request are performance competence details corresponding to at least in part hardware capabilities, software capabilities, connectivity quality, and system health of the client device. The performance competence details from the client device and known performance capabilities of the hardware, software, connectivity, and system health of the client device are input into an algorithm to calculate a performance competence index value. The performance competence index value is used to determine an optimal response corresponding to the performance capabilities of the client device. The optimal response is then sent to the client device by the web server. In an embodiment of the invention, the calculation of the performance competence index value occurs on a gateway which is not located on the web server.

### BRIEF DESCRIPTION OF THE SEVERAL VIEWS OF THE DRAWINGS

FIG. 1 is a pictorial representation of a data processing system for a client device accessing content on a web server in accordance with an embodiment of the present invention.

FIG. 2 is a flowchart depicting the steps of a program for optimizing web content for a client device in accordance with an embodiment of the present invention.

FIG. 3 is a flowchart depicting the steps of a program for a performance competence calculation on a performance competence gateway in accordance with an embodiment of the present invention.

FIG. 4 is a pictorial representation of an example system for client devices of varying performance capability accessing content on a web server in accordance with an embodiment of the present invention.

FIG. 5 is a block diagram of components of computers depicted in accordance with an embodiment of the present invention.

### DETAILED DESCRIPTION

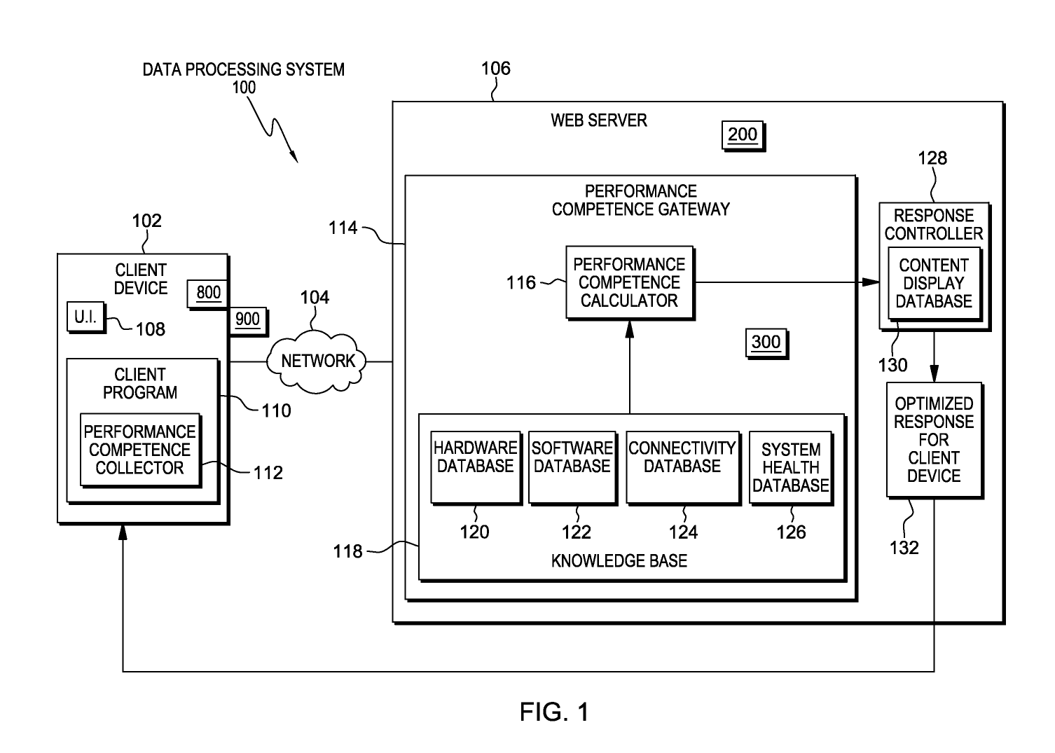

The present invention will now be described in detail with reference to the Figures. FIG. 1 illustrates a data processing system 100 in accordance to one embodiment of the present invention.

Data processing system 100 includes a client device 102 and a web server 106 that are connected through a network 104. Client device 102 may be workstations, personal computers, personal digital assistants, mobile phones, and other devices executing program instructions. A user interface 108 is located on client device 102 and may exist in the form of operating system software, which may be Windows, LINUX, or other systems that include application software such as internet applications and web browsers. Also located on client device 102 is a client program 110 which may exist in the form of a web browser, an instant messaging client, a media streaming client, a File Transfer Protocol (FTP) client, or any other program type. Client program 110 is used to access web content through network 104. Located as a part of client program 110 on client device 102 is a performance competence collector 112. The performance competence collector 112 accesses the system data of client device 102 in order to gather details relating to the performance competence of the specific client device. The performance competence details may correspond to, but are not limited to, the hardware, software, connectivity, and system health details of the client device 102.

In one embodiment, data processing system 100 includes network 104 that provides communication between devices such as, but not limited to, web server 106, and client device 102. Network 104 may include connections such as wiring, wireless communication link, fiber optic cables, and other forms of communication. Network 104 may allow elements of data processing system 100 to access content through a plurality of methods, including the internet, an intranet connection, telecommunications service provider, local area connection, and others.

Web server 106 acts as the host of the content being accessed by client device 102 through network 104. Web server 106 may include application servers, communications servers, database servers, and others. In general, client device 102 and web server 106 may be any programmable electronic devices as described in further detail with regard to FIG. 1. In another embodiment, client device 102 and/or web server 106 represents a “cloud” of computers interconnected by one or more networks, where client device 102 and/or web server 106 is a primary server for a computer system utilizing clustered computer s and components to act as a single pool of seamless resources when accessed through network 104. For example, this implementation may be preferred for data centers and for cloud computing applications. In this example, web server 106 includes an optimized content program 200 to send optimized web content to a client device 102 responsive to receiving performance competence details from the client device 102. In an example, performance competence gateway 114 is located on web server 106. Performance competence gateway 114 may be located on the web server 106, or another server which may exist between the client device 102 and the web server 106, and is connected to the client device 102 and the web server 106 through network 104. In this example, performance competence gateway includes a performance competence gateway program 300 which calculates a performance competence index value responsive to the performance competence details received from client program 110 on client device 102.

In an example, a performance competence calculator 116 and a knowledge base 118 are located on performance competence gateway 114, which is located on web server 106. The performance competence calculator 116 receives performance competence details from the client device 102 and uses these performance competence details along with the information on the knowledge base 118 to compute a performance competence index value. Performance competence calculator 116 may use a predetermined algorithm to compute the performance competence index. The predetermined algorithm ensures that the performance competence index values are the same when run from different client programs 110 but have the same system. The performance competence details input into the algorithm may comprise the number of client device 102 parameters being analyzed, or other indications of client device 102 capabilities. Knowledge base 118 includes databases of information corresponding to performance competence details and how the performance competence details factor into the performance competence calculator 116. The information on knowledge base 118 may include, but is not limited to, a hardware database 120, a software database 122, a connectivity database 124, and a system health database 126. Each database contains information such as weights, performance history and other information relating to their respective categories of performance competence details. The information in each database may be based on historical analytics data, user preference, and other recorded information.

Once the performance competence calculator 116 determines the performance competence index value, the performance competence index value is sent to a response controller 128. In an example, response controller 128 is located on web server 106. Response controller 128 contains a content display database 130. The response controller 128 receives the performance competence index value from the performance competence calculator 116 on performance competence gateway 114. Response controller 128 uses the performance competence index value for the client device 102 to find an optimized response for client device 102 on the content display database 130. Content display database 130 includes different forms of the desired web content that is catered to client devices 102 of varying performance competence. Some examples of content on content display database 130 are content of varying richness, content broken down into portions to be sent separately, or other forms of content. In an example, optimized response for client device 132 is located on web server 106. The optimized response for client device 132 is then sent to the client device 102.

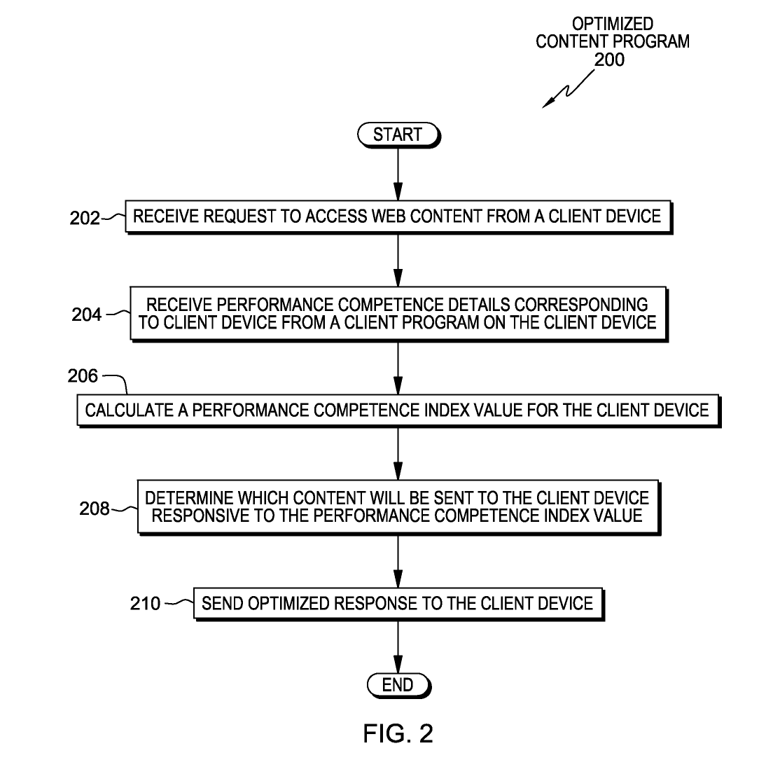

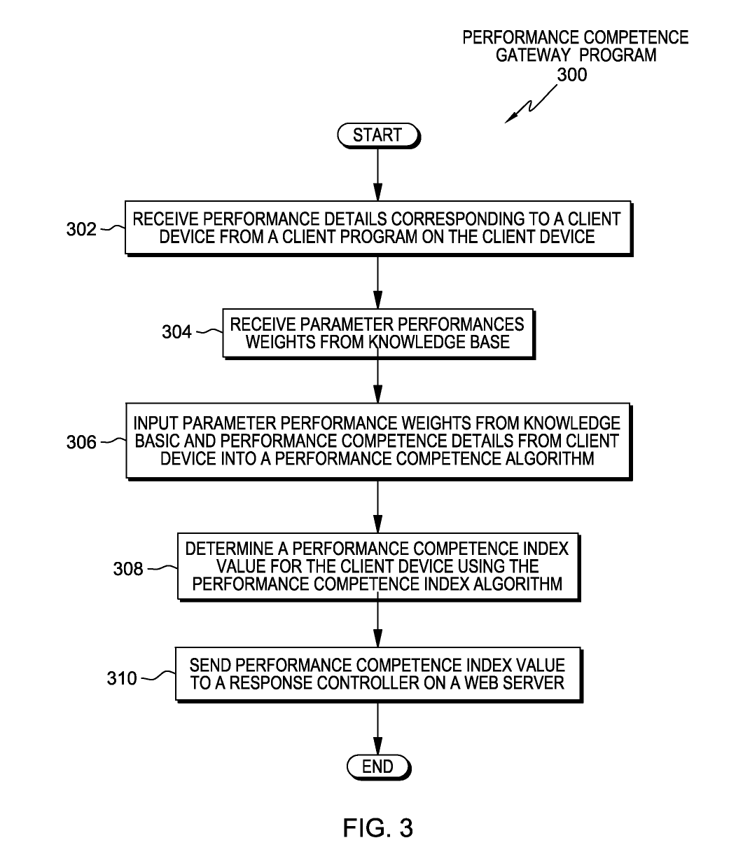

The programs described in FIGS. 2 and 3 may be stored on web server 106 and performance competence gateway 114 in the form of programs on the computing system of web server 106 and performance competence gateway 114. However, in other examples, the programs may be stored on remote storage devices, servers, and other methods.

FIG. 2 is a flowchart of the optimized content program 200. In step 202, optimized content program 200 receives a request to access web content from a client device. Optimized content program 200 receives performance competence details corresponding to client device 102 from a client program 110 on client device 102 (step 204). In step 206, optimized content program 200 calculates a performance competence index value of client device 102. Optimized content program 200 determines which content will be sent to the client device responsive to the performance competence index value (step 208). In step 210, optimized content program 200 sends an optimized response to the client device.

In some examples, optimized content program 200 sends the desired content to client device 102 in a form which is relative to the performance capability of the client device 102. In the known art, a client device 102 that has a poor performance competence index value may receive similar content to a client device 102 with an excellent performance competence index value. This can result in the client device 102, with a poor performance competence index score, receiving content which is difficult for the client device 102 to process. Optimized content program 200 may be initiated when a client device 102 receives a request from a user to access content located on a web server. Once the performance competence index value is calculated, it is sent to the web server as part of the request header which requests to access content on the web server 106.

The performance competence details received in step 204 may be gathered by performance competence collector 112 on client program 110. These performance competence details may correspond to the hardware, software, connectivity, and system health details of the client device 102. Some examples of hardware details that may be collected by the performance competence collector 112 may consist of device type, system memory, hard disk capacity, processor speed and capability, among other hardware components of a computing device. The software details that are collected by the performance competence collector 112 may include the operating system of client device 102, web browser, or other information from software on client device. Some examples of connectivity details collected by the performance competence collector 112 may include network bandwidth, type of network, speed of network, or other detail corresponding to the connectivity of client device 102 to a web server 106. The system health details that may be collected by the performance competence collector 112 may relate to details regarding the condition of client device 102, the age of the components of client device, or other indications of the health of client device.

FIG. 3 is a flowchart of the performance competence gateway program 300. In step 302, performance competence gateway program 300 receives performance competence details corresponding to a client device 102 from a client program 110 on the client device 102. Performance competence gateway program 300 receives parameter performance weights from knowledge base 118 (step 304). In step 306, performance competence gateway program 300 inputs parameter performance weights from knowledge base 118 and performance competence details from client device 102 into a performance competence index algorithm. Performance competence gateway program 300 determines a performance competence index value for client device 102 using the performance competence index algorithm (step 308). In step 310, performance competence gateway program 300 sends the performance competence index value to response controller 128 located on a web server 106.

In some examples, performance competence gateway program 300 uses an algorithm to calculate the performance competence index value for client device 102. Performance competence gateway program 300 is located on performance competence gateway 114. In an example, performance competence gateway 114 may be located on web server 106, but in another example, performance competence gateway may be located on a server separate from web server and client device 102. In this example, the algorithm would be a standard so that all performance competence index values received by web server 106 will be based off of the same calculation and will be comparable. The performance weights from knowledge base 118 correspond to databases including, but not limited to a hardware database 120, a software database 122, a connectivity database 124, and a system health database 126. These databases include known performance capabilities of certain client performance details. In an example, hardware database 120 includes the performance capabilities of a client device 102 with two Gigabytes (GB) of Random Access Memory (RAM) and would assign a performance weight responsive to this information. In another example, the weights in knowledge base 118 may be modified based on a user priority preference. The performance competence index value is used by response controller 128 on web server 106 to determine an optimized response for client device 132.

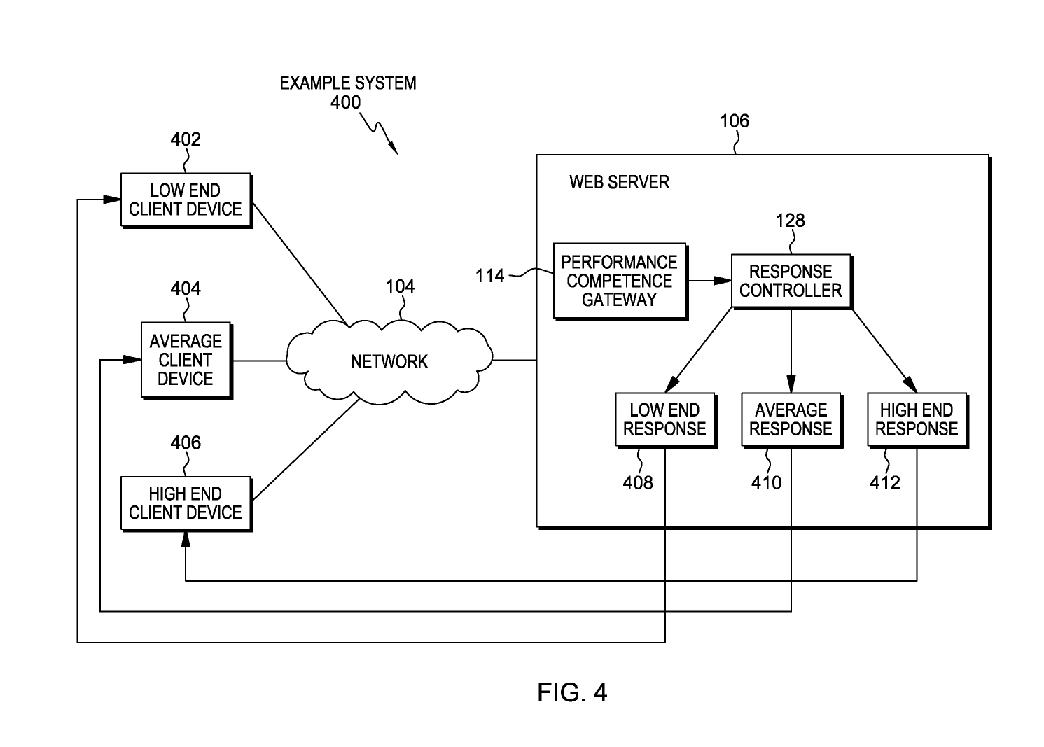

FIG. 4 is an example of a data processing system 400 that includes three client devices of varying performance capability attempting to access the same web content located on web server 106 through network 104. In example system 400, a low end client device 402, an average client device 404, and a high end client device 406 access content located on web server 106 through network 104. An example of low end client device 402 may include hardware components comprising 512 Megabytes (MB) of RAM, and a 1.2 Gigahertz (GHz) dual core processor, software components comprising a mobile device operating system, connectivity information comprising a download speed of 4 MB per second, and system health information indicating a device with a high amount of wear. An example of average client device 404 may include hardware components comprising 2 Gigabytes (GB) of RAM, and a 2.2 Gigahertz (GHz) dual core processor, software components comprising a Windows operating system, connectivity information comprising a download speed of 9 MB per second, and system health information indicating a device with a normal amount of wear. An example of high end client device 406 may include hardware components comprising 4 Gigabytes (GB) of RAM, and a 3.0 Gigahertz (GHz) quad core processor, software components comprising a Windows operating system, connectivity information comprising a download speed of 15 MB per second, and system health information indicating a device with a low amount of wear. Low end client device 402, average client device 404, and high end client device 406 include user interface 108, and client program 110, the latter of which contains the performance competence collector 112 included in client device 102 in FIG. 1.

Performance competence collector 112 detects and collects the hardware, software, connectivity, and system health information for each client device, and sends this information to web server 106 along with the request to access web content. In an example, when the request to access web content is received by web server 106, the performance competence details for low end client device 402, average client device 404, and high end client device 406 are received by performance competence gateway 114. Performance competence gateway 114 includes performance competence calculator 116, knowledge base 118, and competence gateway program 300 included in the performance competence gateway depicted in FIG. 1. The performance competence details received are referenced by knowledge base 118, and each category of performance competence details (hardware, software, connectivity, and system health) are analyzed in accordance with information from each of their respective databases. In an example, performance competence gateway 114 receives the indication that low end client device 402 has 512 Megabytes (MB) of RAM. In this example, hardware database 120 in knowledge base 118 provides a weighting value corresponding to the 512 MB of RAM in low end client device 402. This weighting value can then be input into the algorithm in performance competence calculator 116 along with the performance competence details which may include the number of low end client device 402 parameters to be analyzed or other factors. In this example, performance competence gateway 114 calculates a weighting value for system parameter provided in the performance competence details corresponding to low end client device 402, average client device 404, and high end client device 406. The result is a performance competence index value which represents the performance capability for each client device. In another example, performance competence gateway is located on a separate server other than web server 106, and in this case the request to access web content would be received by performance competence gateway 114 to calculate the performance competence index value before the request is received by web server.

An example for the algorithm used in the performance competence index value calculation may be (CW+SW)/N, where N is the number of system parameters received by performance competence gateway 114 (RAM, processor, operating system, and others), CW is the client weight which is based on all the parameter specific to the client device, and SW is the server weight which is based on historical data and results based on the parameters. To calculate the CW and SW input to the algorithm, the client weights and server weights for each provided parameter are summed together. In the example of low end client device 402, the known parameters are 512 MB of RAM, a 1.2 GHz dual core processor, a mobile device operating system, a download speed of 4 MB per second, and a high amount of system wear. This means that there are 5 parameters provided, therefore N is equal to 5. In this example, the client weights and server weights are assigned on a scale of 1 through 10, one being the least desirable, and 10 being the most desirable. In an example, the client weights provided for the parameters are 3 for 512 MB of RAM, 6 for a 1.2 GHz dual core processor, 4 for a mobile device operating system, 5 for a download speed of 4 MB per second, and 2 for a high amount of system wear. This equates to a value of 20 for the CW (3+6+4+5+2=20). The server weights may also be provided as 2 for 512 MB of RAM, 2 for a 1.2 GHz dual core processor, 4 for a mobile device operating system, 3 for a download speed of 4 MB per second, and 1 for a high amount of system wear. This equates to a value of 12 for the SW (2+2+4+3+1=12). Substituting the known values into the example algorithm yields (20+12)/5, and results in a final performance competence index value of 6.4. This calculation will be completed for each computer in example system 400, and the performance competence index value for each client device is sent to response controller 128.

Response controller 128 receives the performance competence index value from performance competence gateway 114. Response controller 128 includes the content display database 130, which is depicted in FIG. 1. In an example, response controller 128 uses the performance competence index value to choose a response from content display database 130 to send back to low end client device 402, average client device 404, and high end client device 406. In an example, a low end response 408, an average response 410, and a high end response 412 are chosen from content display database 130 and sent to the respective client device. The possible responses considered by response controller 128 may be defined by, but not limited to varying depictions and formatting of content based on ranges of performance competence index values. In an example, low end response 408 is chosen for low end client device 402, and may include a decreased richness of content such as fewer images, basic JavaScript, decreased client side validation, or other changes. In an example, average response 410 is chosen for average client device 404, and may include a scaled richness of content such as advertisements of low complexity, less complex JavaScript, standard resolution images and video, or other changes. In an example, high end response 412 is chosen for high end client device 406, and may include content of a high level of richness such as high definition video and images, complex advertisements, advanced JavaScript, or other high quality content. The response controller can send the chosen form of desired web content to the respective client device.

Example system 400 depicts three client devices of varying performance capability accessing the same web content, and receiving customized responses responsive to the performance capability of each client device. An example, which may be realized, is in an e-commerce environment where the product data, which may be fed to an e-commerce server from a master data management (MDM) system is tweaked and optimized before sending to a mobile device of an end user. In some examples, performance competence gateway 114 may include a cache of performance competence index values for popular client devices. In an example, the cache may include known performance competence index values for mobile devices which repeatedly request to access content on a web server 106. This may reduce the number of repeated calculations and therefore reduce the workload on performance competence gateway 114, allowing performance competence gateway to complete more requests.

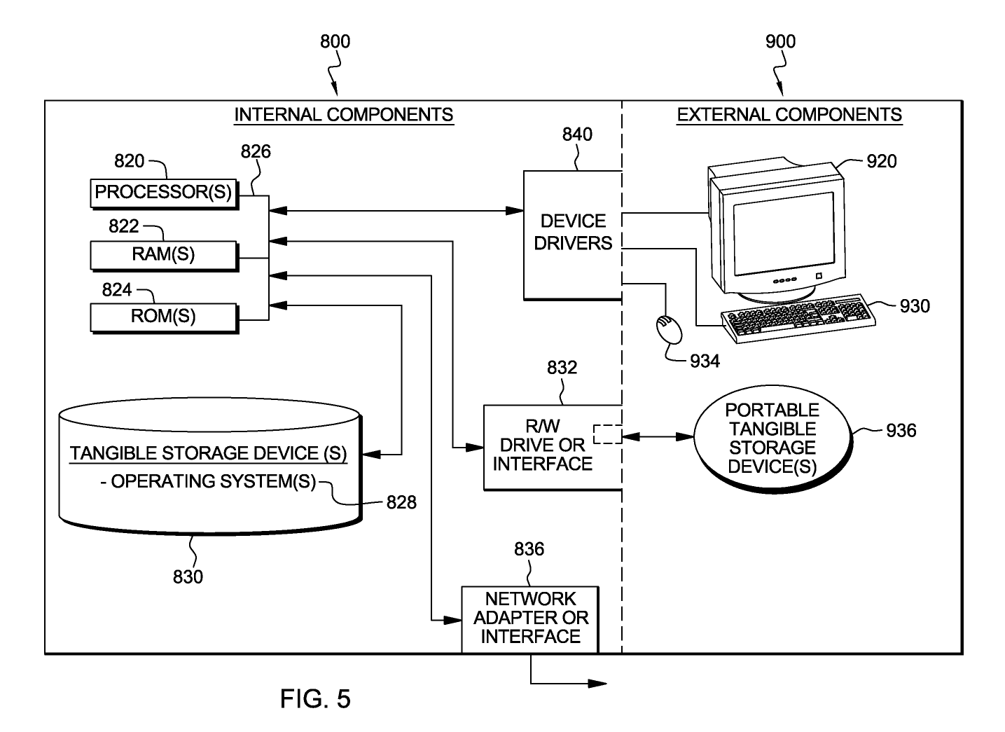

Client device 102 and web server 106 may include respective sets of internal components 800 and external components 900 illustrated in FIG. 5. Each of the sets of internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and optimized content program 200 in client device 102 and program 300 in web server 106 are stored on one or more of the respective computer-readable tangible storage devices 830 for execution by one or more of the respective processors 820 via one or more of the respective RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more portable computer-readable tangible storage devices 936 such as a CD-ROM, DVD, memory stick, magnetic tape, magnetic disk, optical disk or semiconductor storage device. Optimized content program 200 and performance competence gateway program, 300 can be stored on one or more of the portable computer-readable tangible storage devices 936, read via the respective R/W drive or interface 832 and loaded into the respective hard drive 830.

Each set of internal components 800 also includes network adapters or interfaces 836 such as a TCP/IP adapter cards, wireless Wi-Fi interface cards, or 3G or 4G wireless interface cards or other wired or wireless communication links. Optimized content program 200 and performance competence gateway program 300 can be downloaded to client device 102 and web server 106 or other computing devices from an external computer via a network, for example, the Internet, a local area network or other, wide area network, and respective network adapters or interfaces 836. From the network adapters or interfaces 836, the optimized content program 200 and performance competence gateway program 300 are loaded into the respective hard drive 830. The network may comprise copper wires, optical fibers, wireless transmission, routers, firewalls, switches, gateway computers and/or edge servers.

Each of the sets of external components 900 can include a computer display monitor 920, a keyboard 930, and a computer mouse 934. External components 900 can also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Optimized content program 200 and performance competence gateway program 300 can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of optimized content program 200 and performance competence program 300 can be implemented in whole or in part by computer circuits and other hardware (not shown). Based on the foregoing, computer system, method and program product have been disclosed in accordance with the present invention. However, numerous modifications and substitutions can be made without deviating from the scope of the present invention. Therefore, the present invention has been disclosed by way of example and not limitation.

What is claimed is:

1. A method for optimizing content sent from a web server to a client device, comprising the steps of:
a computer receiving a request to access web content from a client device, wherein the request contains performance competence details corresponding to at least in part hardware capabilities, software capabilities, connectivity quality, and system health of the client device;
responsive to receiving performance competence details from the client device, the computer calculating a performance competence index value by utilizing the performance competence details from the client device and known performance capabilities stored in a database that includes at least in part hardware, software, connectivity, and system health of the client device; and
responsive to the calculation of the performance competence index value, the computer determining an optimal response corresponding to the performance capabilities of the client device to be sent to the client device.

2. The method of claim 1, wherein the computer sends the optimal response to the client device.

3. The method of claim 1, wherein the calculation of the performance competence index value occurs on a gateway which is not located on the web server.

4. The method of claim 1, further comprising;
responsive to receiving performance competence details from the client device, the computer requiring more performance competence details to be provided; and
the computer requesting that the client device provide more performance competence details.

5. The method of claim 1, wherein the computer maintains a cache of performance competence index values for client devices that repeatedly request to access the content on the web server.

6. A computer program product for optimizing content sent from a web server to a client device, the computer program product comprising:
one or more computer-readable, tangible storage devices;
program instructions stored on at least one of the one or more storage devices, to receive a request to access web content from a client device, wherein the request contains performance competence details corresponding to at least in part hardware capabilities, software capabilities, connectivity quality, and system health of the client device;
program instructions stored on at least one of the one or more storage devices, responsive to receiving performance competence details from the client device, program instructions to calculate a performance competence index value by utilizing the performance competence details from the client device and known performance capabilities stored in a database that includes at least in part hardware, software, connectivity, and system health of the client device; and program instructions stored on at least one of the one or more storage devices, responsive to the calculation of the performance competence index value, program instructions to determine an optimal response corresponding to the performance capabilities of the client device to be sent to the client device.

7. The computer program product of claim 6, wherein the program instructions to send the optimal response to the client device.

8. The computer program product of claim 6, wherein the program instructions to calculate the performance competence index value on a gateway which is not located on the web server.

9. The computer program product of claim 6, further comprising
program instructions, stored on at least one of the one or more storage devices, responsive to receiving performance competence details from the client device, program instructions to require more performance competence details to be provided; and
program instructions, stored on at least one of the one or more storage devices, to request that the client device provide more performance competence details.

10. The computer program product of claim 5, wherein the program instructions to maintain a cache of performance competence index values for client devices that repeatedly request to access the content on the web server.

11. A computer system for, optimizing content sent from a web server to a client device, the computer system comprising;
one or more processors, one or more computer-readable memories and one or more computer-readable, tangible storage devices;
program instructions, stored on at least one of the one or more storage devices for execution by at least one of the one or more processors via at least one of the one or more memories, to receive a request to access web content from a client device, wherein the request contains performance competence details corresponding to at least in part hardware capabilities, software capabilities, connectivity quality, and system health of the client device;
program instructions, stored on at least one of the one or more storage devices for execution by at least one of the one or more processors via at least one of the one or more memories, responsive to receiving performance competence details from the client device, program instructions to calculate a performance competence index value by utilizing the performance competence details from the client device and known performance capabilities stored in a database that includes at least in part hardware, software, connectivity, and system health of the client device; and
program instructions, stored on at least one of the one or more storage devices for execution by at least one of the one or more processors via at least one of the one or more memories, responsive to the calculation of the performance competence index value, program instructions to determine an optimal response corresponding to the performance capabilities of the client device to be sent to the client device.

12. The computer system of claim 11, wherein the program instructions to send the optimal response to the client device.

13. The computer system of claim 11, wherein the program instructions to calculate the performance competence index value on a gateway which is not located on the web server.

14. The computer system of claim 11, further comprising;
program instructions, stored on at least one of the one or more storage devices for execution by at least one of the one or more processors via at least one of the one or more memories, responsive to receiving performance competence details from the client device, program instructions to require more performance competence details to be provided; and
program instructions, stored on at least one of the one or more storage devices for execution by at least one of the one or more processors via at least one of the one or more memories, to request that the client device provide more performance competence details.

15. The computer system of claim 11, wherein the program instructions to maintain a cache of performance competence index values for client devices that repeatedly request to access the content on the web server.
